(19) United States
(12) Patent Application Publication
(10) Pub. No.: US 2026/0134423 A1
(43) Pub. Date: May 14, 2026

(54) TEMPORARY DEVICE IDENTIFIER

(71) Applicant: DABCO LIMITED, Newbury, Berkshire (GB)

(72) Inventors: Yakeen PRABDIAL, London (GB); David PALMER, London (GB)

(21) Appl. No.: 19/119,372

(22) PCT Filed: Oct. 12, 2023
(86) PCT No.: PCT/GB2023/052643

§ 371 Date: Apr. 8, 2025

(30) Foreign Application Priority Data
Oct. 12, 2022 (GB) 2215052.8

(51) Int. Cl. G06Q 20/38; G06Q 20/36

(52) U.S. Cl. CPC G06Q 20/3829; G06Q 20/36; G06Q 20/389

(57) ABSTRACT

Method and system for a first device to interact securely with a second device, the method comprising the steps of receiving a request to create a transaction between the first device and the second device, the request received by a server in communication with a ledger. Determining if the second device is registered with the server, and if the second device is not registered with the server, then the server assigning a symmetric key to the second device, wherein the symmetric key is associated with a UICC of the second device. Generating a public and private key pair of the second device, wherein the private and public key pair is associated with the symmetric key. The server generating a wallet of the second device on the ledger, wherein the wallet has a wallet ID and the wallet ID is associated with the public and private key pair. A HSS providing credentials of the second device to the server. The server associating the provided credentials with the symmetric key. Generating a transaction on the ledger between the wallet of the second device and a wallet on the ledger of the first device, wherein the transaction is signed by the private key of the second device.

### FIELD OF THE INVENTION

The present invention relates to a system and method for devices to interact securely by recording transactions on a distributed ledger.

### BACKGROUND OF THE INVENTION

There is a common need for different entities to interact and transact with each other to exchange value and data. However, for this to be done in a safe and secure manner for each party to a transaction, a level of trust is required to exist between transacting entities. In the absence of such trust, other structures and procedures are necessary such as enforceable contracts and third-party authorities or intermediaries.

Cryptocurrencies are digital currencies that are a form of alternative currency (or private currency). They are usually distinct from centrally controlled government-issued currencies (for example, fiat money) and offer a decentralised or distributed form of currency and/or medium of exchange. Digital currencies may be transacted or transferred from one owner or entity to another and may be used for any purpose, such as buying goods, purchasing services or even obtaining data. As such, digital currencies represent an alternative to traditional currencies.

One example of a cryptocurrency is bitcoin, although many other cryptocurrency systems have been devised. Bitcoin was developed by Satoshi Nakamoto and the original paper, ‘Bitcoin: A Peer-to-Peer Electronic Cash System’, outlining the fundamentals of bitcoin technology and principles may be found at https://bitcoin.org/bitcoin.pdf.

Technology underlying distributed cryptocurrencies, such as distributed ledgers, can also be used to record other types of transactions and can form a verifiable history of exchanges or other forms of data without requiring trust to exist between entities. Distributed ledgers, such as blockchains, enable transactions and exchanges of value to occur in the absence of such trust. However, this requires the use of public blockchains to form a consensus that is difficult to corrupt or control by any individual actor or entity. This usually takes the form of a race to consensus based on a proof of work but this itself can consume very high levels of resources in the form of computing and electrical power.

An alternative approach uses private blockchains but this reintroduces the requirement for trust to be developed between parties and the owner and controller of the private blockchain itself.

Trust can be developed by determining and verifying the identity or other characteristics of entities, but this effort can introduce overheads and additional work leading to inefficiencies and extra load for a computer system or a telecommunications network. Furthermore, such verification or checks often depend on separate sources of information, each of which may also need to be verified and approved or trusted. This may require significant bandwidth and processing resources. Therefore, this approach may only be appropriate for certain entities transacting above a particular value, where the overheads do not become a significant burden. This also prevents new exchanges of value and data from developing between entities that are new to each other or transient exchanges of low value but at high volume. For small or numerous entities or devices, such as those forming the internet of things (IoT) or other low computing power devices, the overheads can vastly overwhelm the small exchanges of value. Therefore, this limits the efficiency and scalability necessary for exchanging value or data packages, especially for autonomous or unsupervised devices.

Therefore, there is required a method and system that overcomes these problems.

### SUMMARY OF THE INVENTION

A system and method are provided that enable two or more devices to interact and exchange information or carry out other transactions securely. At least one of the devices is preregistered or otherwise known to the system. Another device is unregistered. For example, the unregistered device may be roaming on a visited telecommunications network but contains a UICC or SIM to enable roaming. The transactions between the devices are recorded and can be validated using a blockchain or distributed ledger.

The unregistered device needs to have a wallet (with a wallet ID) on the ledger. The system generates a symmetric key for the unregistered device and associates this symmetric key with the UICC or SIM of the unregistered device. A public and private key pair is also generated and associated or assigned to the symmetric key. Furthermore, a wallet and a ledger account is created and associated or assigned to the public and private key pair. A device identifier (e.g., its IMSI) may also be associated with the wallet ID and an account identifier. A home subscriber server (HSS) provides credentials of the unregistered device and these credentials are associated with the symmetric key. Therefore, the HSS of a telecommunications network can use the security of the UICC or SIM to provide a verifiable identity of the wallet on the ledger. It also provides a means for generating payments for any transactions (e.g., using a billing system of the telecommunications network). This enables secure interactions with other devices or entities that are registered with the system (in a similar way). Transactions can then be generated and signed using the private key of the unregistered device (now registered securely with the system). The system may be a server or platform, for example.

In accordance with a first aspect, there is provided a method for a first device to interact securely with a second device, the method comprising the steps of:
receiving a request to create a transaction between the first device and the second device, the request received by a server in communication with a ledger (e.g., a distributed ledger or blockchain);
determining if the second device is registered with the server, and if the second device is not registered with the server:
   the server assigning a symmetric key to the second device, wherein the symmetric key is associated with a UICC of the second device,
   generating a public and private key pair of the second device, wherein the private and public key pair is associated with the symmetric key,
   the server generating a wallet of the second device on the ledger, wherein the wallet has a wallet ID and the wallet ID is associated with the public and private key pair;
a home subscriber server (HSS) providing credentials of the second device to the server;
the server associating the provided credentials with the symmetric key; and
generating a transaction on the ledger between the wallet of the second device and a wallet on the ledger of the first device, wherein the transaction is signed by the private key of the second device. Therefore, a device (the second device) that is unknown to the system (e.g., does not yet have a wallet on the ledger) can interact and transact (exchange information and value) securely with a device that is known and registered with the system. Preferably, the first device already has a wallet ID on the ledger and associated public and private key pair with an assigned symmetric key that is associated with a UICC or SIM of the first device. Preferably, the ledger is a distributed ledger. Preferably, the ledger is a blockchain. The first (or second) device may be part of a server or platform that provides a service (e.g., parking or electric charging services) to the second (or first) device. Recording exchanges of data only (i.e., without an exchange of value or currency) in this verifiable and safe way is also advantageous as such data can be shared securely between devices that are not initially registered with the same system.

Preferably, the method may further comprise the step of registering the UICC of the second device on the HSS. This is preferably carried out in advance and before the other steps. Therefore, the second device is registered on the network (e.g., roaming) so that it can have access to data services and its identity is verified in advance (i.e., using its UICC or SIM).

Optionally, the step of generating the wallet of the second device may further comprise providing the wallet with credit. The credit may represent a currency credit or other forms of value. Therefore, this can improve efficiency as the second device can exchange value without having to add funds to the wallet in advance. The risk of default (not paying back the credit) is low as the second device's identity has been verified by the HSS and roaming changes can be recorded and incurred and used to pay back any spent credit.

Optionally, the credit may be stored as a token in the wallet. Other mechanisms may be used, including storing the value of the credit directly.

Advantageously, the transaction may transfer at least a portion of the credit on the wallet of the second device to the wallet of the first device. The transaction may also or alternatively, involve the transfer of data or information and this transfer can be recorded on the ledger.

Optionally, the second device may be roaming, the method may further comprise the step of settling a sum of one or more transactions of the wallet of the second device using a roaming charging platform associated with the HSS. Therefore, visitors to a network (e.g., from abroad) can safely transact with other local users or services (i.e., the first device). When the second device is not roaming then the usual home charging system may be used.

Preferably, the step of settling the sum of one or more transactions of the wallet of the second device may further comprise the roaming charging platform generating a call detail record, CDR, including a roaming charge on the HSS. Other payment mechanisms may be used.

Optionally, the method may further comprise the step of signing the CDR using the private key of the second device. The signed CDR may also be recorded on the ledger. The signed CDR may be verified before the charges are issued or added to a billing system.

Optionally, the value of the roaming charge on the CDR may be recorded as roaming minutes.

Optionally, the method may further comprise the step of providing the wallet of the second device with additional credit. This may take place before or after any original credit has run out or expired.

Optionally, the settling step may further comprise the step of authenticating the one or more transactions on the ledger using the public key of the second device. Therefore, transactions can be verifiable and reduce the occurrence of disputed transactions.

Optionally, the step of the server assigning a symmetric key to the second device may be triggered by a smart contract. The smart contract may also trigger other events, including the provision of services to or from the second device or the user of the second device (e.g., to or from the first device).

Optionally, the step of the HSS providing credentials of the second device to the server may be triggered by the or another smart contract.

Optionally, the symmetric key may be configured to expire after a predetermined time. The symmetric key may be replaced using a similar process up to or after expiration, for example.

Preferably, the wallet ID may be further associated with an international mobile subscriber identity, IMSI, of the second device. Therefore, the wallet ID may be associated directly or indirectly with the second device using different unique identifiers.

In accordance with a second aspect there is provided a system comprising:
a server;
a ledger associated with the server;
a home subscriber server, HSS;
a roaming settlement system; and
a computer program comprising instructions which, when the program is executed by one or more computers, cause the one or more computers to carry out any or all of the described methods.

The methods described above may be implemented as a computer program comprising program instructions to operate a computer. The computer program may be stored on a computer-readable medium.

The computer system may include a processor or processors (e.g., local, virtual or cloud-based) such as a Central Processing Unit (CPU), and/or a single or a collection of Graphics Processing Units (GPUs). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows (RTM) or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a flowchart of a method for two or more devices to interact securely;

FIG. 2 shows a schematic diagram of a system used to implement the method of FIG. 1, given by way of example only;

FIG. 3 shows a schematic diagram of a further system used to implement the method of FIG. 1;

FIG. 4 shows a schematic diagram of a further system used to implement the method of FIG. 1; and

FIG. 5 shows a sequence diagram illustrating further aspects of the method of FIG. 1.

It should be noted that the figures are illustrated for simplicity and are not necessarily drawn to scale. Like features are provided with the same reference numerals.

### DETAILED DESCRIPTION OF THE PREFERRED EMBODIMENTS

The ‘Internet of Things’ is growing and transitioning to an ‘Economy of Things’ (ET). The number of IoT devices is growing and generating large volumes of data. IoT devices and smart services interact and interoperate across ownership domains and offer the potential to support data and smart service value transactions automatically in near real time. This can improve interoperability and functionality.

The ‘Economy of Things’ requires the capability for devices/services to identify, trust each other, and where required automatically transact value and/or information directly or using peer-to-peer functionality. There are a range of technologies ranging from Distributed Ledger, Secure Elements, Cryptography and Device Wallets which support Digital ID, Federated Security and transaction applications and services needed for IoT, but they are fragmented, have high costs and are not sufficiently scalable.

It is important for different entities and devices to interact securely. In some situations, a device that is registered and known to a system (e.g., based on a distributed ledger) needs to interact with another device or entity that is currently unknown to the system. Those interactions can be recorded as transactions on a ledger (e.g., a distributed ledger implementing a blockchain). For example, this allows devices that may be roaming on to a telecommunications network to use and provide services to other devices and entities.

There are billions of devices currently in operation however these devices may be siloed within separate systems. Without explicit contracts between system operators, including expensive integration processes, these separate devices are limited in how they interact with each other and in interoperating dynamically in order to conduct transactions to exchange information, provide services and exchange value.

The described system and method solves this problem by introducing a smart encryption trigger to authenticate devices that may be operating on other subscriber networks or otherwise unregistered with the system. In summary, this method uses PKI asymmetric encryption by using a private key of a public and private key pair that is provisioned or stored on to a UICC or SIM of a device, so that the device can externally sign onto distributed ledger technology (DLT). A smart contract triggers a home subscriber server (HSS) to authenticate the device (the device ID). Where no private key is available to the device (because this may be its first transaction using the method and system and the device is currently unregistered), the smart contract triggers the generation of a unique symmetric key, which is associated with the UICC or SIM of the device. The symmetric key is linked to a private key and ledger ID and account associated with a device ID key (e.g., IMSI) on the DLT.

When a transaction is requested (e.g., by a party to the transaction or by an external system) and no corresponding account and private key is found on the ledger for one party or device) then a symmetric key (preferably timebound) is generated and a corresponding private key and wallet and account is associated with the device on a migrant node. The migrant node is for devices requiring additional authentication provided by the HSS. This also involves creating a temporary ledger ID.

Devices on the migrant node may be associated with a smart contract to trigger authentication of the UICC or SIM by the HSS. However, the account (wallet) does not have any credit with which to carry our transactions.

Loading a HSS transaction token balance into the device wallet is required. When device authentication is established, a timebound token may be created and loaded into the device wallet setting a roaming balance to cover one or more transactions. The HSS identity and authentication credentials (obtained from the HSS) will be associated with the temporary ledger ID and a device state within the system is moved to Transaction Ready.

Token HSS settlement is achieved by interacting with a cellular billing system. A hash of the token balance for each device is written to the migrant node. A smart contract for token settlement generates a synthetic call detail record (CDR) (i.e., synthetic in that it is not generated from an telecommunications service such as SMS, voice or data) for settlement on a roaming platform of the cellular communications system (e.g., Syniverse RTM or the Vodafone VRS Billing Evolution Engine). In the event that the HSS cannot resolve the device's identity, then a decentralized device ledger or other trusted blockchains may be used for authentication and other private keys issued by those systems may be used to sign the authentication transaction. However, these other trusted blockchains are not necessary when HSS authentication is achieved. Where no device or authentication is possible then the temporary credentials associated with the device may expire (e.g., immediately or after a predetermined period).

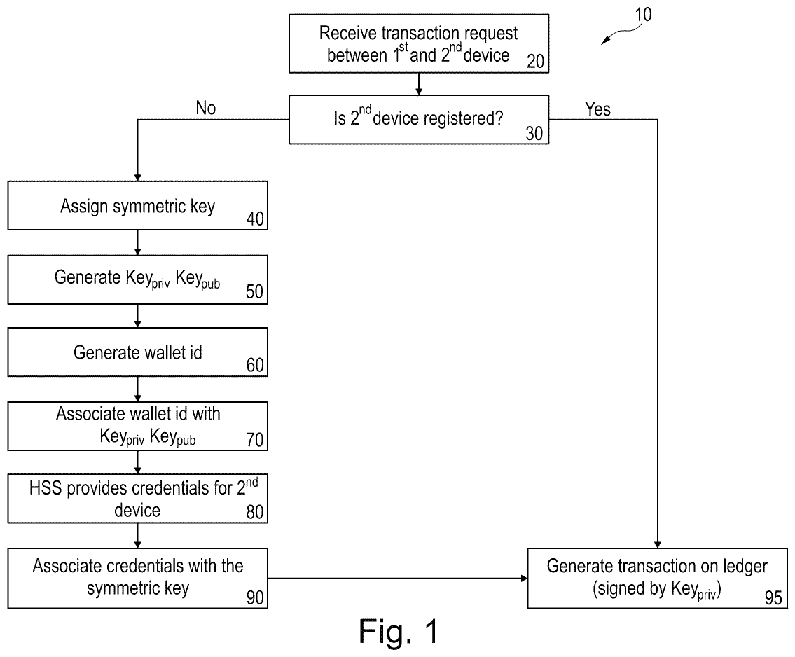

FIG. 1 shows a flowchart of a method 10 for achieving this functionality. At step 20, a transaction request is received by the system or platform. The system may be known as a digital asset brokerage (DAB) or a DAB platform. A determination is made as to whether or not one of the devices (second device in this example) is registered with the system or platform at step 30 (i.e., already possess a private key used to sign transactions). If the second device is already registered, then the method 10 may proceed directly to generating a signed transaction on the ledger (step 95). However, when a determination is made that the second device is not registered then a series of further steps (40-70) takes place.

At step 40 the system or platform assigns a symmetric key to the second device. The symmetric key may be generated by a hardware security module or any other suitable means within the system. The symmetric key is transmitted (e.g., securely using cellular communications) to the second device. This may be achieved by any suitable secure provisioning. At step 50, a private public key pair (Keypriv Keypub) is generated. This key pair may be stored by a UICC or other secure element of the second device.

At step 50 a wallet having a wallet ID is generated for operation on the ledger (distributed ledger or blockchain). The wallet ID is associated with the key pair at step 70. The second device should already be provisioned for use on a cellular telecommunications network. The cellular telecommunications network has a home subscriber server (HSS). At step 80, the HSS provides the server or platform with credentials of the second device. The server or platform associates the credentials with the symmetric key at step 90. Therefore, the server or platform has now registered the second device, which is able to conduct transactions using its private key to sign them. At step 95, the originally requested transaction (see step 20) is now added to the ledger in a form that is signed by the private key of the second device for future verification. In this way, the first and second devices interact and conduct transactions securely. In some example implementations, a smart contract triggers these steps when particular conditions are met. For example, the smart contract may carry out the test as to whether the second device is registered and if not then proceeds with registration steps 40 to 90. In an example implementation a service provider (e.g., an operator of the first device) may trigger the smart contract to carry out the registration steps.

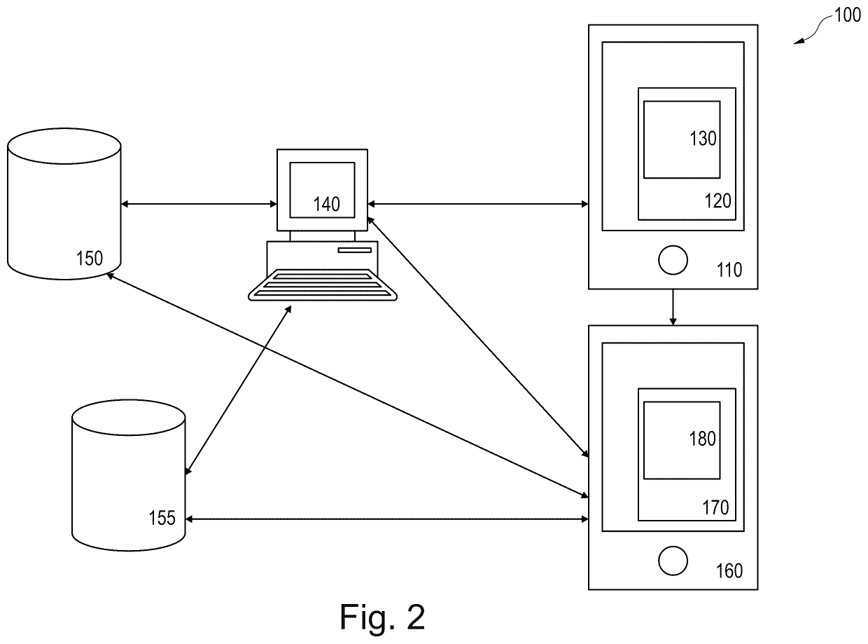

FIG. 2 shows a schematic diagram of an example system 100 (at a high level) used to implement the method 10 described with reference to FIG. 1. The first device 110 (registered before a transaction is requested), having a SIM 120, and the server 140 (DAB) communicate securely over a communications channel, such as a cellular communications channel. The second device 160 (unregistered with the server 140 before the transaction is requested) also has a SIM 170 and communicates both with the first device 110 and the server 140 of the platform. The distributed ledger 150 receives the instruction to execute transactions from the server 140. The HSS 155 both enables the second device 160 to access the cellular telecommunications network (not shown in this figure) and to provide credentials of the second device 160 to the server 140. The private and public keys and the symmetric keys of each device are stored securely within secure storage 130 and 180 of the first and second devices, respectively.

Scalability and interoperability are key capabilities for IoT transactions and payments. In the described system and method, the HSS 150 is used for quick scalable authentication of IoT devices so that devices can trust each other and authenticate their associated wallets for transactions.

In a first scenario a registered or first device 110 (e.g., registered in the ledger and operating within its home network that is also configured to use the described system and method 10) interacts with a similarly registered device to create exchanges of data, services and other transactions. The home HSS 150 is used to authenticate both devices, transactions are routed to the ledger 155 for devices to sign transactions.

In a second scenario, a registered device 110 (i.e., as above) wishes to transact with a device 160 that is not operating within its home network (e.g., it may be roaming). However, the roaming device 160 has been previous registered on the ledger and has already been set up with its private and public key pair, its symmetric key and has a wallet ID and account on the ledger 155. Authentication is achieved for both devices and the roaming device is registered or set with the status of certificate authority (CA) credentials checked. The device is verified and approved, and a proxy wallet and ledger ID assigned on the ledger 155 for carrying out transactions. Symmetric SIM Trust (or other example secure applications operating within a SIM or UICC) may be used to sign the transactions.

In a third scenario, a registered device 110 wishes to transact with an unregistered device 160 (e.g., one that has not had any interactions with the system). In this scenario the unregistered device 160 is not registered on ledger 155, and so the system 100 may check whether other trusted device blockchains (not shown in this figure) are available to authorise the unregistered device 160. Where the device ID is validated, the device 160 will be approved and a proxy wallet and ID are assigned on by the server 140 for handing transactions. Again, symmetric SIM trust (or other example secure applications operating within a SIM or UICC) may be key used to sign transactions on the ledger 155.

In the second and third scenarios the proxy ID and wallet may be used to create a permanent ID and wallet on the ledger 155. Where a device or user of a device wants to port to the system, then their ledger ID can become their master ID and a virtual overlay SIM profile may be provisioned using the HSS 150 for the migration.

This method 10 facilitates improved functionality and interoperability between different entities and optionally enhances compatibility between different blockchains. This includes “classical” wallet functionality as well as enabling the processing traditional payment rails.

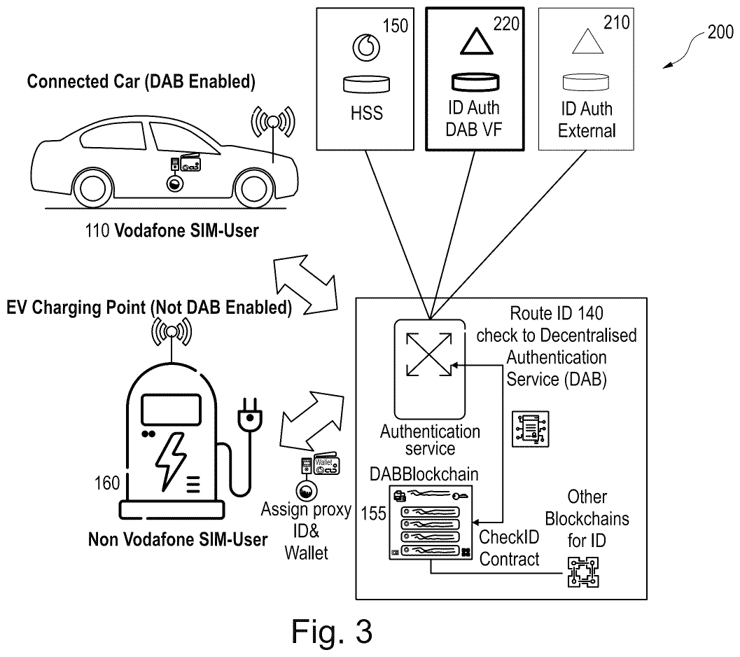

FIG. 3 shows a schematic diagram for a further example implementation 200. In this example implementation 200 the first device 110 is a vehicle that includes a SIM 120. This first device 110 is already registered with the system 100. The second device 160 provides electric charging services but is not registered with the system 100. The second device 160 is roaming onto the same cellular telecommunications system that is used by the first device 110 but this is not essential. The server 140 in this example is designated as DAB. In this example, the transaction is the provision of electric charging services in exchange for value (ultimately currency). The HSS 150 provides the credentials of the second device 160. Two additional authentication services carry out authentication functions. ID auth DAB External 210 provides external authentication (e.g., using a separate blockchain). ID auth DAB VF 220 authenticates devices (e.g., transactions signed using their private keys) within the ledger 155.

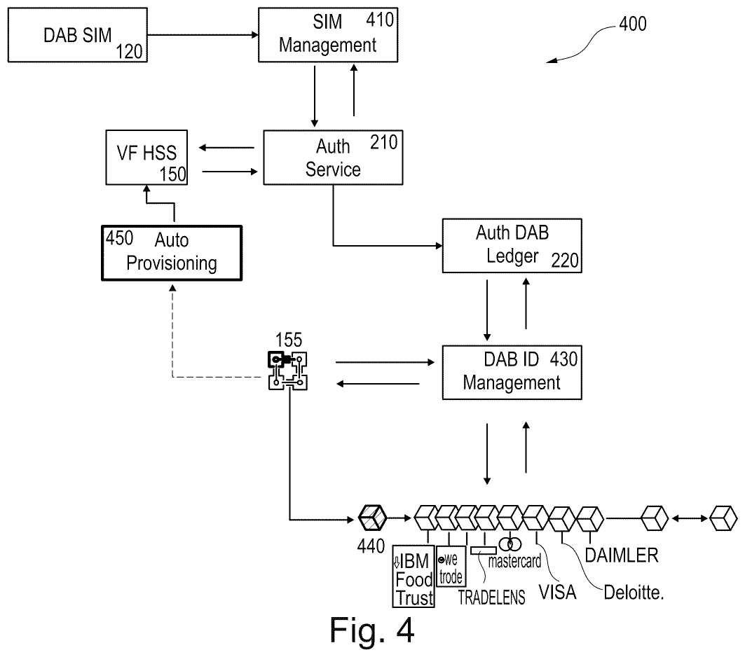

FIG. 4 shows schematically components of a system 400 and a flow of data and method steps for operating the example implementation of FIG. 3. DAB SIM 120 is within the vehicle (first device) 110. SIM management component 410 provides the symmetric and public and private key pairs to SIMs within devices, as well as managing authentication. DAB ID management component 430 is part of the system 100 and generates wallet IDs for the ledger 155 and interacts with a roaming settlement system 440 that can generate call detail records (CDRs) used to cover transaction costs. The roaming settlement system 440 includes payment rails for obtaining payments to cover the roaming charges and other billed costs. Auto provisioning component 450 associates the device credentials obtained from the HSS 150 with the wallet ID, device identifier (e.g., IMSI) and device account on the ledger 155.

Starting with the DAB SIM 120, a device authorisation request is made with the SIM management component 410. The authorisation request is made to the Auth Service 210. Where the HSS 150 is not resolved (no device credentials can be provided), the Auth DAB Ledger 220 communicates with the DAB ID management component 430, which determines that the device 160 is not found on the DAB ledger 155 and so attempts to authenticate the device 160 using other trusted blockchains.

The DAB ledger 155 assigns a proxy ID and proxy wallet to the requested transaction (e.g., payment for charging services). These are added to the migrant node on the DAB ledger 155.

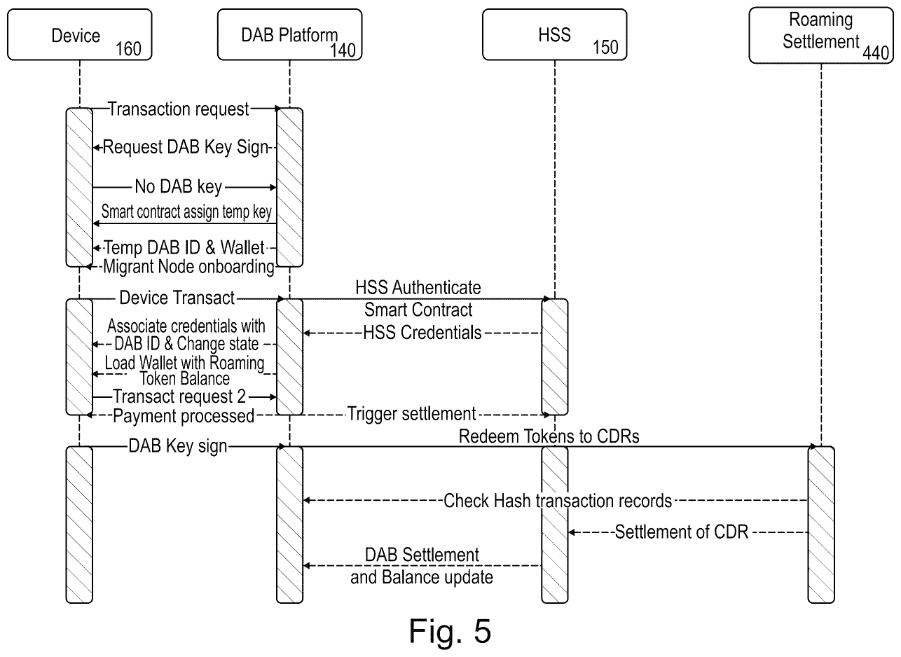

FIG. 5 shows a sequence diagram of the method 10 in more detail. A device (i.e., an unregistered device or the second device 160) makes a transaction request to the DAB platform or server 140. The DAB platform (server) 140 responds by asking the device 160 to sign the transaction using their DAB (private) key. The device 160 responds that they do not have a DAB key. This triggers the smart contract (within the server 140) to assign the device 160 with a temporary (symmetric) key. The DAB platform (server) 140 also generates a temporary ledger ID (DAB ID) and a wallet having a wallet ID. This constitutes steps for onboarding the device 160 onto a migrant node of the DAB ledger 155.

The device 160 can continue the transaction with another device 110, which may be a standalone device or part of a larger (e.g., external) system. A request is triggered by the smart contract to the HSS 150 to provide credentials of the device 160. The HSS 150 responds with the requested credentials. These credentials are associated with the ledger ID (DAB ID) and a status of the account is changed to Transaction Ready. The DAB platform (server) 140 generates credit for the device in the form of a token having a token balance. The device 160 can now pay for transactions.

The DAB key (public key now stored within the SIM 170 of the device 160) can be used to sign transactions. However, the provided credit may deplete or require topping-up. Therefore, the tokens can be redeemed against CDRs generated by the billing system or roaming settlement system 440. The roaming settlement system 440 confirms transactions on the ledger 155 within the DAB platform 140 by checking their hashes. For transactions authenticated in this way, then the roaming settlement system 440 settles each CDR with the HSS 150, which generates a cost (or credit where services are provided) on the next bill or statement for a user or entity that owns the device 160. Once such a settlement has occurred then a balance update can be made to credit the wallet ID on the DAB ledger 155.

As will be appreciated by the skilled person, details of the above embodiment may be varied without departing from the scope of the present invention, as defined by the appended claims.

For example, some or all of the authentication steps may be avoided or dispensed with by using machine learning. Devices that act in a particular way or exhibit particular behaviours may be determined by the machine learning model to be more trusted and so require fewer authentication steps. This can be determined dynamically and over time. Whilst only two devices are shown in the examples, any number of devices (both registered and unregistered) may be part of the system.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method for a first device to interact securely with a second device, the method comprising the steps of:
receiving a request to create a transaction between the first device and the second device, the request received by a server in communication with a ledger;
determining if the second device is registered with the server, and if the second device is not registered with the server:
the server assigning a symmetric key to the second device, wherein the symmetric key is associated with a UICC of the second device,
generating a public and private key pair of the second device, wherein the private and public key pair is associated with the symmetric key,
the server generating a wallet of the second device on the ledger, wherein the wallet has a wallet ID and the wallet ID is associated with the public and private key pair;
a home subscriber server, HSS, providing credentials of the second device to the server;
the server associating the provided credentials with the symmetric key; and
generating a transaction on the ledger between the wallet of the second device and a wallet on the ledger of the first device, wherein the transaction is signed by the private key of the second device.

2. The method according to claim 1, the method further comprising the step of registering the UICC of the second device on the HSS.

3. The method of claim 1, wherein the step of generating the wallet of the second device further comprises providing the wallet with credit.

4. The method of claim 3, wherein the credit is stored as a token in the wallet.

5. The method of claim 3, wherein the transaction transfers at least a portion of the credit on the wallet of the second device to the wallet of the first device.

6. The method according to 3, wherein the second device is roaming, the method further comprising the step of settling a sum of one or more transactions of the wallet of the second device using a roaming charging platform associated with the HSS.

7. The method of claim 6, wherein the step of settling the sum of one or more transactions of the wallet of the second device further comprises the roaming charging platform generating a call detail record, CDR, including a roaming charge on the HSS.

8. The method of claim 7 further comprising the step of signing the CDR using the private key of the second device.

9. The method of claim 7, wherein the value of the roaming charge on the CDR is recorded as roaming minutes.

10. The method according to claim 7 further comprising the step of providing the wallet of the second device with additional credit.

11. The method according to claim 6, wherein the settling step further comprises the step of authenticating the one or more transactions on the ledger using the public key of the second device.

12. The method according to claim 1, wherein the step of the server assigning a symmetric key to the second device is triggered by a smart contract.

13. The method according to claim 1, wherein the step of the HSS providing credentials of the second device to the server is triggered by a smart contract.

14. The method according to claim 1, wherein the symmetric key is configured to expire after a predetermined time.

15. The method according to claim 1, wherein the wallet ID is further associated with an international mobile subscriber identity, IMSI, of the second device.

16. A system comprising:
a server;
a ledger associated with the server;
a home subscriber server, HSS;
a roaming settlement system; and
a computer program comprising instructions which, when the program is executed by one or more computers, cause the one or more computers to carry out the method according to claim 1.
